(19) United States
(12) Patent Application Publication
(10) Pub. No.: US 2025/0187953 A1
(43) Pub. Date: Jun. 12, 2025

(54) COAGULANT SLURRY COMPOSITIONS PRODUCED FROM DRINKING WATER TREATMENT RESIDUALS

(71) Applicant: U.S. PEROXIDE, LLC, Atlanta, GA (US)

(72) Inventors: Eunkyung JANG, London (CA); John WALTON, Auburn, CA (US); Domenico SANTORO, London (CA); Wayne PARKER, Waterloo (CA)

(73) Assignee: U.S. PEROXIDE, LLC, Atlanta, GA (US)

(21) Appl. No.: 18/973,593

(22) Filed: Dec. 9, 2024

Related U.S. Application Data
(60) Provisional application No. 63/607,378, filed on Dec. 7, 2023.

(51) Int. Cl. C02F 1/52; C02F 11/04

(52) U.S. Cl. CPC C02F 1/5245; C02F 11/04; C02F 2303/20

(57) ABSTRACT

A coagulant slurry composition is described that is derived from drinking water treatment residuals, which includes a particulate component having porous particles containing iron and aluminum, and a dissolved component that includes dissolved forms of the iron species and the aluminum species. The coagulant slurry composition can be prepared by dewatering and roasting the drinking water treatment residuals to provide a powder composition, and then digesting or dissolving a portion of the powder composition in an acid or a base.

### CROSS-REFERENCE TO RELATED APPLICATION

This application claims the earlier filing date benefit of U.S. Provisional Application No. 63/607,378, filed on Dec. 7, 2023, the entirety of which is incorporated by reference herein.

### BACKGROUND

Chemical coagulants, particularly iron and aluminum coagulants, are used to treat municipal and industrial wastewaters. Aluminum and iron chemicals can be used in collection systems or treatment plants. Iron chemicals are used for sulfide control in both the collection system and treatment plant, and for phosphorus and suspended solids removal. Aluminum chemicals are used primarily in the treatment plants for phosphorus and suspended solids removal.

Iron and aluminum coagulants are also used in drinking water treatment, particularly for removing turbidity and colloidal matter from surface water supplies. Solids residues generated during treatment of surface drinking water supplies typically contain, in addition to the source water constituents and other minor impurities, spent iron and aluminum coagulants. The most common disposal route for those drinking water treatment residues is landfilling, which incurs additional costs and precludes future coagulant recovery/re-use.

From a critical supply perspective, drinking water takes precedence over wastewater. During times of coagulant supply disruption, wastewater treatment facilities are impacted first. Additionally, the iron and aluminum coagulant markets are highly commoditized and compete with the larger metal materials market for scrap feedstock. This trend has been persistent and is accelerating as electric arc furnaces (that use scrap/recycled steel) replace more energy-intensive blast furnaces (that require refined iron ore). These factors have driven the historical price for iron coagulants to increase by more than 5% per year over the past 25 years.

### SUMMARY

This disclosure provides an alternative source for coagulants that is based on the iron and aluminum residues from drinking water treatment facilities. According to one aspect, this disclosure provides a coagulant slurry composition that is derived from drinking water treatment residuals, and includes a particulate component having porous particles containing an iron species and an aluminum species, and a dissolved component that includes dissolved forms of the iron species and the aluminum species.

According to another aspect, this disclosure provides a method of producing a coagulant composition that includes providing a calcined or pyrolyzed powder composition that includes both iron and aluminum from drinking water treatment residuals, and mixing an acid or base with the powder composition to dissolve a portion of the powder composition and provide a slurry composition that includes a particulate component with particles that includes iron and aluminum and a dissolved component that includes dissolved iron and dissolved aluminum.

### BRIEF DESCRIPTION OF THE DRAWINGS

FIG. 1 is a schematic diagram of a method of producing a coagulant slurry composition; and

FIGS. 2A and 2B are photographs respectively showing a mixed and a settled coagulant slurry composition.

### DETAILED DESCRIPTION OF EMBODIMENTS

This disclosure provides a coagulant slurry composition that is based on residuals from treating drinking water, methods for making the same, and methods of using the coagulant slurry composition. The coagulant slurry composition includes a particulate component and a dissolved component, each of which includes iron and/or aluminum in some form. As discussed in greater detail below, the coagulant slurry composition also has unique properties that differentiate it from conventional iron or aluminum coagulants, that render the slurry composition particularly suitable for certain end-uses that benefit from the presence of particulate components as well as dissolved metal species, or otherwise benefit from having both iron and aluminum functionality. For example, the coagulant slurry composition can be used in various municipal wastewater treatments. These end-uses of the coagulant slurry composition will also often benefit from being in the same locality as drinking water plants where the coagulant slurry can be made, which reduces shipping costs.

### Production Methods

The coagulant slurry composition described herein is produced from drinking water treatment residuals, such as drinking water sludge. These types of residuals are a byproduct of chemical treatments of water that render it suitable as drinking water, and also include materials that are present in the natural water source. In particular, surface water is typically treated with aluminum and/or iron coagulants to reduce turbidity, pathogens and colloidal matter in the water. The surface water can be added to a clarifier with the coagulants, which causes the coagulated solids to settle at the bottom of the clarifier tank. Mineral alkali (e.g., lime) is also commonly added in drinking water facilities to assist flocculation or add alkalinity to the finished water, and a portion of the mineral alkali will partition into the residue. The surface water may also naturally include other minerals and clays (e.g. as silt) such as calcium, magnesium, silica, and aluminosilicates. Such minerals may also include those from living organisms such as zebra mussels' shells. The clarified water is typically filtered to remove organics or colloidal components, e.g., with membrane filters, sand filters, activated carbon, etc. Backwash from the filtering systems can also be added to the separated clarifier solids. This backwash may contain sand, garnet, mineral substances, and activated and/or colloidal carbon. Thus, the drinking water treatment residuals can include aluminum and iron species from the coagulants, a silica component, and other minerals such as calcium, sodium, potassium, and magnesium. The treatment residuals can also include carbonaceous components.

The drinking water treatment residuals can be decanted from the clarifier or otherwise separated from the treated water. The residuals taken from the clarifier typically have a solids content of about 1-5%. Many water treatment facilities will further dewater the residuals as drinking water sludge, which typically has solids contents of 10-40%, or from 15% to 35%.

Based on the wide variety of different water sources and the differences in coagulant treatments and filtration among drinking water plants (as well as the treatment differences among seasons, weather conditions, time of day, etc.), the relative amounts of the various components in the drinking water treatment residuals can vary greatly. However, the drinking water treatment residuals will generally include iron and aluminum. One of these metal species may be present in greater amounts than the other depending on whether the drinking water plant uses a primarily iron coagulant treatment or a primarily aluminum coagulant treatment. In the case of drinking water sludge, at the least one of the iron and aluminum can be present in an amount of 1,000 ppm (mg/L) or more, such as from 5,000 ppm to 100,000 ppm, or from 7,500 ppm to 40,000 ppm, 20,000 ppm to 35,000 ppm, or from 35,000 ppm to 75,000 ppm, for example.

Once the drinking water treatment residuals are separated, the methods of producing the coagulant slurry composition according to this disclosure can optionally include further dewatering the residuals (including, e.g., drinking water sludge) so that the residuals have solids content of 20% or more, e.g., 25%-80%, 50% to 100%, or from 30% to 50%. This can be accomplished by allowing the settled solids to further compress in storage or drying the residuals at temperatures of from 60 to 120° C., or from 90° C. to 110° C., for example, at durations of from 2 h to 72 h, from 5 h to 48 h, or from 15 h to 36 h. A vacuum, pressure filter, solar light, or centrifuge could optionally be used to assist in dewatering the residuals.

Optionally, supplemental materials can be added to the drinking treatment water residuals either before or after dewatering, but generally before the thermal treatment described below. Supplemental materials may include chemicals, minerals, or biological materials. For example, trace minerals, aluminosilicates, bentonite clay, and combustible carbonaceous materials (e.g., biomass, cellulosic compounds, or wastewater treatment residuals) can be added as supplementary materials to increase the porosity and surface area of the produced particulates, increase biocatalytic functionality, and/or improve dissolution in the acid or base solution.

The drinking water treatment residuals can then be subjected to a thermal treatment that effectively roasts the residuals, removes substantially all remaining water, and chemically changes the mineral species in the residuals. For example, the thermal treatment can include a calcining process in which the residuals are heated in the presence of oxygen at temperatures of from 250° C. to 1000° C., from 400° C. to 900° C., or from 500° C. to 750° C., and for a duration that is in a range of 0.2 h to 24 h, from 0.5 h to 6 h, or from 1 h to 4 h, for example. The thermal treatment can alternatively include a pyrolysis process (e.g., in a pyrolyzer) in which the residuals are heated to the aforementioned temperatures and durations in an atmosphere that is substantially devoid of oxygen. The temperature of the thermal process and the amount of oxygen present will affect the product composition, and both variables can be independently controlled to affect the desired structures and properties in the final product, including e.g., the crystallinity of the particles and the amount and nature of carbonaceous materials in the slurry composition. A vacuum could also optionally be used with these thermal processes.

The thermal treatment can be applied for a sufficient duration to remove substantially all of the remaining water to provide a powder composition having, e.g., less 0.5 wt. % or less than 0.1 wt. % water.

The duration and temperature of the thermal treatment can be controlled so that at least some of the organic material in the drinking water treatment residuals is burned or decomposes. This can create a powder composition in which the particles have a porous structure, e.g., the pores are formed where organics have been incinerated, and the walls of the pore are formed of various mineral species such as aluminum, iron, and silicon species. In embodiments where oxygen is present in the heat treatment, these mineral species may exist primarily as oxides in the powder composition.

While the above-described thermal treatment is performed in some embodiments of the inventive methods, it may also be possible to prepare the coagulant slurry composition by acquiring a powder composition that has already been thermally treated. In this regard, some water treatment facilities incinerate drinking water sludge as a means of disposal, and it may be possible to recover ash from such incineration processes to use as the thermally treated powder composition.

Once the powder composition is prepared by the thermal treatment, the powder composition can optionally be mechanically processed to reduce the particle size such as by grinding or milling the powder composition (e.g., in a hammer mill).

The powder composition is mixed with acid or base to at least partially digest the powder composition so that at least a significant portion (e.g., at least 10 wt. %) of the iron and aluminum are dissolved to produce a slurry in which minerals exist in a dissolved from and a particulate form (including colloidal forms for purposes of this disclosure). A sufficient amount of acid or base can be added so that the ultimate slurry composition has a solids content of from 5 wt. % to 60 wt. %, from 10 wt. % to 40 wt. %, or from 15 wt. % to 25 wt. %. The solution of the acid or base and powder composition can be mixed for at least 6 h, at least 24 h, or at least 48 h for example, at speeds in a range of from 25 g to 100 g g-Force, and at a temperature that is in a range of from 20 to 80° C., for example. Sonication can be applied to the composition to promote dissolution. The acid or base used to dissolve the powder composition can have a concentration of from 0.05 to 10 M, 0.1 M to 5 M, or from 0.5 to 2 M, for example. In embodiments, the powder composition can be mixed with a mineral acid such as hydrochloric acid or sulfuric acid, which can hydrolyze and at least partially dissolve the powder.

In certain embodiments, it is possible to take advantage of the inherent acidity present in some commonly available coagulant formulations, such as ferric chloride (FeCl₃) or aluminum chloride (AlCl₃), to achieve partial or complete dissolution of the powder composition. These formulations typically have a low pH and high acidity, which can be harnessed to replace or supplement the need for a separate acid addition. For example, ferric chloride solutions used in wastewater treatment often have a pH ranging from −1 to 2, making them an effective acid source for dissolving the powder composition into a slurry. By utilizing such formulations, the overall chemical input can be reduced, lowering production costs and minimizing the environmental impact of the process. The use of these acidic coagulant formulations can also simplify logistics in wastewater treatment facilities where ferric chloride or similar compounds are already in use, as the same inventory can be repurposed for the coagulant slurry production process. Using these coagulants as at least part of the acidic medium introduces a circular economy concept where waste from drinking water treatment plants (e.g., sludge) is valorized into a functional coagulant slurry, while leveraging conventional treatment chemicals to minimize additional resource use, and has the following advantages:
1. Efficiency in Dissolution: The acid in ferric chloride or aluminum chloride not only aids in dissolving the powder composition but also introduces dissolved ferric or aluminum species directly into the slurry, thereby enriching the dissolved component of the final coagulant product.
2. Process Optimization: The presence of additional dissolved metal species from these coagulants reduces the processing time and energy required to achieve target dissolution levels for the powder composition.
3. Reduced Chemical Handling: Leveraging the existing acidity of these coagulants reduces the need for handling and storing additional strong acids, such as hydrochloric or sulfuric acid, improving operational safety and streamlining plant operations.

In some embodiments, a chemical reductant such as sulfurous acid can also be combined with the powder composition or the slurry during the digestion step to increase the solubilization of the powder composition. Reducing agents can enhance the solubility of metals in acids by altering the oxidation states of the metal or preventing the formation of insoluble oxides. Common examples of reducing agents include hydrogen gas (H₂), which, under high temperatures and pressures, can promote metal dissolution in acids like hydrochloric acid, and sulfur dioxide (SO₂), which is effective in reducing metal oxides such as MnO₂ to soluble forms like Mn²⁺. Formic acid (HCOOH) and ascorbic acid are mild reducing agents that are particularly useful for noble metals like gold, often in combination with hydrochloric or nitric acids. Stronger agents like hydrazine (N₂H₄) and sodium borohydride (NaBH₄) are effective for reducing metal ions to more soluble forms. Solid reducing agents such as iron or zinc powder can dissolve in acids to produce hydrogen gas, which further aids in the dissolution of other metals. These agents are widely used with acids such as sulfuric acid, hydrochloric acid, or aqua regia in processes such as metal refining and leaching. The choice of reducing agent depends on the metal being dissolved and the reaction conditions.

The produced coagulant slurry product may optionally undergo subsequent separation processes to either increase or reduce the ratios of soluble to particulate fractions in the final product depending on the desired end-use application.

### Coagulant Slurry Composition

The coagulant slurry composition includes a particulate component and a dissolved component. The particulate component includes particles that include an iron species and an aluminum species, and the dissolved component includes the iron species and the aluminum species that are dissolved in liquid. The iron species in the coagulant slurry composition can include iron salts, in particular ferric salts such as ferric chloride (FeCl₃). The aluminum species can include aluminum salts, in particular trivalent aluminum salts such aluminum chloride (AlCl₃). In the case of using sulfuric acid, the ferric and/or aluminum salts can include ferric sulfate and/or aluminum sulfate. The iron species and aluminum species are each present in the slurry in a dissolved form and a particulate form. In this regard, at least 1 wt. % of the total iron and at least 1 wt. % total aluminum in the slurry composition should be dissolved. For example, from 5 wt. % to 90 wt. %, from 10 wt. % to 75 wt. %, or from 20 wt. % to 60 wt. % of the total amount of iron in the slurry composition can be dissolved. And from 5 wt. % to 90 wt. %, from 10 wt. % to 75 wt. %, or from 20 wt. % to 60 wt. % of the total amount of aluminum in the slurry composition can be dissolved. The substantial remainder of these species that is not dissolved can be present in particulate form. The slurry composition can have from 10 to 90 wt. %, 20 to 80 wt. %, or from 30 to 70 wt. % total particulates.

The inventors discovered that the extent of dissolution (% dissolved) of the aluminum species and the iron species in particular change somewhat over time in the slurry coagulant composition. As recited in the claims below, and as used herein, the numerical values for the amount of particulates in the slurry composition, or the amount of dissolved aluminum or iron in the slurry composition refer to ranges in which the measured value should remain when the slurry composition is stored at room temperature and measured over the course of 7 days.

As indicated above, the slurry composition can have a solids content of from 5 wt. % to 75 wt. %, from 10 wt. % to 50 wt. %, or from 15 wt. % to 30 wt. %, or any range of solids content that allows the slurry to remain mixable and pumpable. The solids content can be selected based on the drinking water residue characteristics, desired mixability, and/or desired pumpability, for example. The slurry composition can include a weight ratio of iron to aluminum (based on only the metal weight) that is in a range of from 1:100 to 100:1, from 1:25 to 25:1, or from 1:3 to 3:1, for example. The slurry composition can have a total iron content (based on the weight of Fe) of from 1 to 75 wt. %, from 5 to 50 wt. %, or from 10 to 30 wt. % on a dry basis. The slurry composition can have a total aluminum content (based on the weight of Al) of from 1 to 75 wt. %, from 5 to 50 wt. %, or from 10 to 30 wt. % on a dry basis. In some embodiments, the aluminum is present in greater amounts than the iron, and in other embodiments the iron is present in greater amounts than the aluminum. To moderate product variability, the iron and/or aluminum content in the solid or liquid fraction can be adjusted by blending the produced slurry with batches of differing metal concentrations or by incorporating externally sourced commercial iron or aluminum products.

The coagulant slurry composition also typically includes silica, calcium, and carbonaceous materials that are present in at least the particulate portion of the slurry. The slurry composition can also include one or more of potassium, magnesium, sodium, and phosphorous species. If mineral acids are used to dissolve the powder composition, the coagulant slurry composition will also include the corresponding anions into the product, e.g., chloride or sulfate anions.

The coagulant slurry composition can have a pH that is from 0 to 4.5, 0.1 to 3, from 0.2 to 2, or from 0.5 to 1.5, for example. In other embodiments in which base is used to partially dissolve the powder composition, the coagulant slurry composition can have a pH that is from 11 to 14, from 12 to 13.8, or from 12.5 to 13.5, for example.

The particles in the particulate component of the slurry are porous. It is believed that the porous structure is formed by incinerating organic materials during the thermal treatment, which creates voids in the solid regions of the particles that includes the minerals identified above. The porosity increases the surface area of the particle, which can increase the reactivity with the iron and aluminum species.

The particles in the particulate component of the slurry can have a particle size distribution such that over 50% of the particles have a size that is below 5 μm, or at least 50% of the particles have a size that is below 3 μm, and in some aspects 55 to 85% of the particles can have a size that is below 3 μm. The particle size distribution of samples of the slurry are measured using a Beckman Coulter Multisizer. Prior to measurement, the samples are prepared by diluting a known quantity in an electrolyte solution, such as isotonic saline or a conductive buffer, to achieve the recommended particle concentration for the instrument (Isotonic saline buffer was used). The solution facilitates electrical conductivity for accurate particle detection. To ensure homogeneity, the sample is gently agitated, and any visible debris or bubbles were removed to prevent interference. The Beckman Coulter Multisizer 4e should be calibrated using standard calibration beads and set up according to the manufacturer's instructions, and selecting the appropriate aperture size and particle size range (100 um aperture is used). The prepared sample is introduced into the instrument, and measurements are performed under continuous stirring to maintain a uniform suspension. Data is analyzed using the software provided with the instrument, yielding the particle size distribution and count based on the Coulter Principle.

In one aspect, the coagulant slurry composition can be made by the methods described in detail above. However, the invention is not so limited, and other methods or variations of the above-described method can be used to make the coagulant slurry composition.

### End-Use Applications

The coagulant slurry compositions are particularly effective for end-use applications in which the particulate portion and the dissolved portion of the slurry act together to provide a benefit.

In one embodiment, the coagulant slurry composition can be added to sewer systems to control biofilms. It is believed that the particulate component of the slurry composition can act as a diffusion barrier on the biofilm that disrupts the biofilm's normal uptake of food and nutrients and/or discharge of waste, and the dissolved portion can complex with and precipitate from the bulk water soluble microbial wastes that emerge from the biofilm (for example, sulfide and phosphate). These precipitated sulfide and phosphate components can then settle onto the biofilm and contribute to the aforementioned diffusion barrier. The reduction of biofilm activity in the sewer system can control odorants such as hydrogen sulfide and organic odorants, and can further reduce greenhouse gas emissions such as methane, nitrous oxide, and/or carbon dioxide.

In one embodiment, the coagulant slurry can perform its function where it is injected and can have sequential effects in the later stages of treatment. For example:
1. The coagulant slurry added into the sewer can control sulfide and phosphorus. Followed by that, the slurry can create the particles in sewer which are ready to settle in the clarifier. This will help reduce the coagulant dose in the clarifier since the particulate coming into the clarifier is settleable already.
2. The slurry added into the clarifier can be used in sulfide and phosphorus control and CEPT (Chemically Enhanced Primary Treatment) and primary solids thickening. The coagulant slurry composition can be added in a clarifier tank in a sewage treatment system for enhanced clarification when clarifier residence times are low. This can occur, for example, during peak-flow hours or bypass rainfall events when even high doses of conventional coagulants do not exhibit good performance. The coagulant slurry composition acts as a ballasted coagulant that can improve clarification because the dissolved portion acts as a conventional coagulant and the particulate portion acts as a ballast that promotes separation and settling of the coagulated particles. In this context, the coagulant slurry composition can further reduce the levels of total suspended solids (TSS), biochemical oxygen demand (BOD), and soluble phosphorous. In one embodiment, the particulate fraction in the slurry mixture may contain iron particles that are magnetic and can be separated from the settled solids and recycled to the clarifier influent as additional ballast.
3. Unsettled particulates, such as iron sulfide, formed through reactions with sulfides in the sewer or clarifier (assuming the slurry is introduced at these stages), can be oxidized and regenerated as iron within the bioreactor (aeration tank) through aeration. The regenerated iron then reacts with phosphorus in the bioreactor, facilitating enhanced phosphorus removal.

In one embodiment, the coagulant slurry composition can be used to enhance phosphorous removal in the primary, secondary and/or tertiary clarification steps in wastewater treatment. Although conventional ferric or aluminum coagulants are used in these process, in instances of high wastewater flow or low phosphorous levels in discharge permits, the performance of conventional coagulants may not be sufficient. The coagulant slurry composition described herein can be added to one or more of these clarifier stages at peak flow hours or following rainfall events, particularly where high rainwater flows are diverted from a biological treatment plant into a storm water by-pass treatment facility that deploys iron or aluminum coagulants to facilitation physical-chemical treatment of the by-pass flows. Here also, the coagulant slurry composition can act as a ballasted coagulant to enhance the settling of biomass in these environments.

In other embodiments, the coagulant slurry composition can be used in wastewater solids thickening, anaerobic digestion, and dewatering. Iron is commonly added to thickeners, digesters and dewatering systems (e.g., centrifuges and filter presses) to increase the solids content, control odors, reduce H₂S, control soluble phosphorous and struvite scaling, reduce polymer requirements, and reduce water content in dewatered solids. However, conventional iron chemicals have little benefit to core digester performance (i.e., conversion of solids to biogas), and preferentially bind to sulfide species. In contrast, because the coagulant slurry composition described in this application includes both iron and aluminum components in soluble and particulate forms, the particulate iron component is expected to enhance core digester performance by enhancing the rates of biogas production, while the aluminum component, which is less impacted by the presence of sulfide, is able to bind soluble phosphorous and prevent struvite scaling.

In one embodiment, the coagulant slurry composition can be added to composting solids to control odors and enrich the solids with soil and plant micronutrients.

### EXAMPLES

### Drinking Water Sludge Characterization

1. Iron-based drinking water sludge was obtained from a drinking water plant that typically disposes its drinking water sludge in landfills or for use on agricultural land. The river source water undergoes coagulation and flocculation with ferric chloride, followed by sedimentation, filtration using an activated carbon and sand filter, and disinfection. The settled solids have a solids concentration of 3%, and the plant dewaters the sludge to a solids concentration of 22 to 35%. The metal composition in the sludge (as % dry weight) was measured as follows:

| | | Element | | | | | |
|---|---|---|---|---|---|---|---|
| | | Fe | Al | Ca | K | Mg | P |
| Dewatered | % | 64.3 | 35.7 | <0.01 | <0.01 | <0.01 | <0.01 |
| Solids | | | | | | | |

2. Aluminum-based drinking water sludge was obtained from a drinking water plant that typically disposes its drinking water sludge by incineration, landfilling, or recycling. The lake source water undergoes coagulation, sedimentation, filtration, disinfection (chlorine) and fluoridation. The chemical treatment that is added to the water includes alum (as a coagulant), chlorine (disinfectant), sodium silicate (corrosion control), fluoride (dental), and sometimes activated carbon (taste and odor control). The settled solids have a solids concentration of 1-3%, and the plant dewaters the sludge to a solids concentration of 12%. The metal composition in the sludge (as % dry weight) was measured as follows:

Element

| | | Fe | Al | Mg | Ca | Na | K |
|---|---|---|---|---|---|---|---|
| Dewatered | % | 1.3 | 76.5 | 0.05 | 18.3 | 1.4 | 1.9 |
| Solids | | | | | | | |

3. Aluminum-based drinking water sludge was obtained from a drinking water plant that typically disposes its drinking water sludge by landfilling. The lake water source undergoes pre-chlorination, coagulation and flocculation, filtration (gravel, sand and anthracite layers), and post-chlorination process. The drinking water plant dewaters the settled solids to a concentration or 19%. The metal composition in the sludge (as % dry weight) was measured as follows:

Element

| | | Al | Ca | Fe | K | Mg | P |
|---|---|---|---|---|---|---|---|
| Dewatered | % | 74.5 | 13.0 | 4.2 | 1.7 | 6.1 | 0.5 |
| Solids | | | | | | | |

### Production Methods

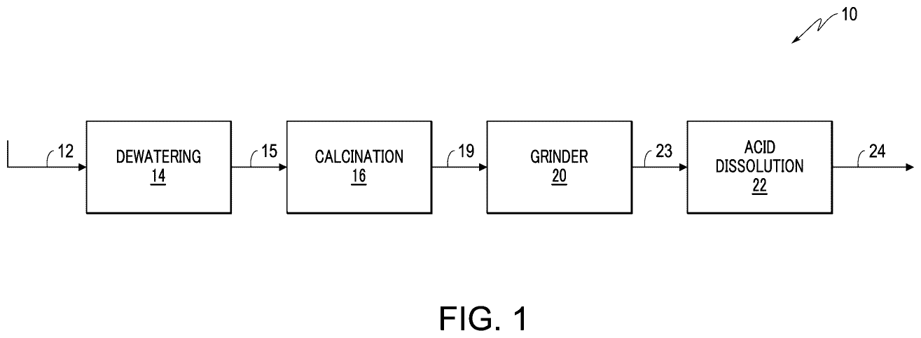

One exemplary embodiment of the process for producing the coagulant slurry composition is illustrated in the schematic diagram shown in FIG. 1. In FIG. 1, a drinking water sludge feedstock 12 is provided, and is then dried in an oven 14 at 105° C. for 24 h. The dewatered feedstock 15 has a solids content of about 80%. The dewatered feedstock 15 is then subjected to a calcination thermal treatment process in oven 16 where the feedstock is heated to 550° C. for 4 h in the presence of oxygen to produce a powder composition 19. After this thermal treatment, the powder composition 19 was grinded in a grinder 20 to reduce the particle size and make the particle size more consistent. Then, hydrochloric acid is mixed with the ground powder composition 23 in acid digestion tank 22 at a ratio of 230 g of powder composition per L of hydrochloric acid, and the mixture is stirred at 900 rpm for 24 hours at room temperature (25° C.) to provide a coagulant slurry composition 24.

In another embodiment of a production method, which is prospective, drinking water treatment residuals are thermally treated to produce a powder composition with high solids content (e.g., 80-100%). This powder is then mixed with an aqueous ferric chloride solution at concentrations ranging from 1 to 5 M. The acidic nature of the ferric chloride dissolves a portion of the powder composition while simultaneously contributing to the dissolved ferric component of the slurry. The mixture is agitated at 700-900 rpm for 24 to 48 hours at temperatures between 20° C. and 80° C. to ensure thorough dissolution and homogenization of the slurry. By utilizing ferric chloride or similar formulations, the final coagulant slurry composition can maintain a solids content of 10-50 wt. % and an optimal pH range of 0.5 to 2. Additional acids may be added to fine-tune the pH if necessary, depending on the specific application requirements.

### Coagulant Slurry Compositions

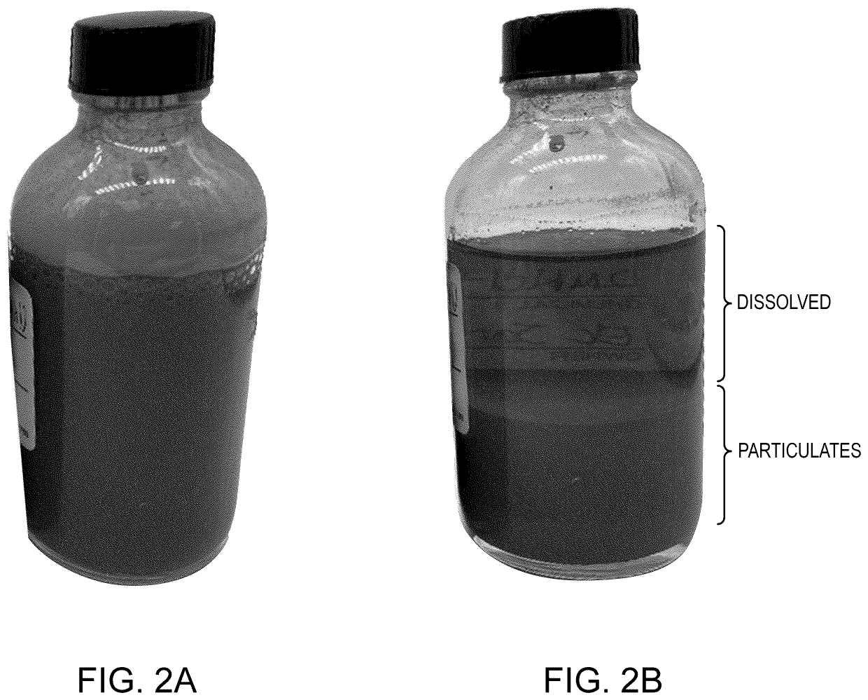

A coagulant slurry composition produced according to the first method described above is illustrated in FIG. 2A, which shows the composition when mixed, and FIG. 2B, which shows the composition when the particulates have been allowed to settle. FIG. 2B more clearly illustrates the particulate component and the dissolved component of the composition. A particle size analysis was conducted on the particulates and it was found that the majority of the particles exhibited a particle size below 2.5 μm (e.g., more than 70%) with about 10-20% of particles being less than 3.5 μm but greater than 2.5 μm.

The coagulant slurry composition had a pH of 1 and exhibited an iron dissolution rate (dissolved iron/total iron) that ranged between about 32% to 56% over the course of 21 days, and also exhibited relative high dissolution levels of aluminum, e.g., varying from about 165 mg to about 215 mg of dissolved aluminum per g of solids over the course of 21 days.

It was also discovered in various experiments shown in Tables 1a and 1b Table 2 below that several factors can affect the dissolution amount and stability of the iron and aluminum species including (i) the acid or base that is used to digest the powder composition; (2) the final pH of the slurry composition; and (3) the thermal treatment that is applied.

The tables below show how the iron and aluminum partition into particulate fractions (Table 1a) and dissolved fractions (Table 1b) in the coagulant slurry compositions given different treatment conditions. In the examples shown below, a powder composition is prepared from different drinking water treatment residuals with different thermal treatments. “Al” refers to a sample that is from a primarily aluminum-based drinking water treatment feedstock, “Fe” refers to a sample that is from a primarily iron-based drinking water treatment feedstock, and “AS” refers to a second aluminum-based drinking water sludge. Samples identified with “105” are dried at 105° C. for 24 h with no additional thermal treatment. Samples identified with “550” are thermally treated at 550° C. for 4 h in an oxygen-containing atmosphere. The sample identified as “AS-PY” is pyrolyzed aluminum sludge that is subjected to a pyrolysis treatment at 300° C. for 2 h in a pyrolyzer and subsequently cooled for 3-4 hours. The sample identified as “AS-PY-550” refers to a sample of the pyrolyzed aluminum sludge that is then cooked in a muffle furnace at 550° C. The “Treatment” refers to the solution that is added to the powder composition to create the slurry composition. The units in the Tables is mg/L.

TABLE 1a
Particulate Fraction

| | | | | | | | 0.1N HCl + | |
|---|---|---|---|---|---|---|---|---|
| | DI Water | | 0.1N HCl | | 1N HCl | | Sonication | |
| Treatment | Fe | Al | Fe | Al | Fe | Al | Fe | Al |
| Al-105 | 2.0 | 65.0 | 1.2 | 9.7 | 1.0 | 7.3 | 10.0 | 17.2 |
| Al-550 | 7.0 | 65.3 | 1.5 | 14.5 | 1.1 | 7.3 | 13.1 | 30.4 |
| Fe-105 | 10.0 | 10.0 | 6.2 | 8.6 | 1.1 | 7.3 | 10.4 | 15.9 |
| Fe-550 | 5.0 | 3.5 | 1.1 | 7.3 | 8.0 | 10.2 | 14.4 | 16.4 |
| AS-105 | nd | 4.5 | 1.1 | 7.3 | 10.0 | 439.0 | 10.5 | 17.5 |
| AS-550 | nd | 9.5 | 1.1 | 7.3 | 3.9 | 23.7 | 11.4 | 19.1 |
| AS-PY | 5.0 | 6.0 | 1.0 | 7.3 | 2.2 | 11.8 | 10.4 | 17.8 |
| AS-PY- | nd | 12.0 | 4.2 | 25.0 | 3.6 | 14.6 | 11.0 | 19.7 |
| 550 | | | | | | | | |

TABLE 1b
Dissolved Fraction

| | | | | | | | 0.1N HCl + | |
|---|---|---|---|---|---|---|---|---|
| | DI Water | | 0.1N HCl | | 1N HCl | | Sonication | |
| Treatment | Fe | Al | Fe | Al | Fe | Al | Fe | Al |
| Al-105 | 0.0 | 0.7 | 0.1 | 19.9 | 1.0 | 428.7 | 1.1 | 209.1 |
| Al-550 | 0.0 | 0.0 | 0.6 | 47.4 | 1.1 | 352.6 | 5.2 | 787.5 |
| Fe-105 | 0.4 | 0.0 | 13.4 | 2.2 | 129.0 | 8.8 | 81.6 | 11.5 |
| Fe-550 | 0.3 | 0.1 | 8.1 | 4.3 | 28.2 | 4.7 | 39.6 | 23.8 |
| AS-105 | 0.2 | 1.0 | 0.7 | 42.1 | — | — | 2.2 | 188.2 |
| AS-550 | 0.2 | 9.7 | 4.0 | 51.0 | 30.0 | 382.6 | 36.3 | 564.1 |
| AS-PY | 0.3 | 12.8 | 4.2 | 26.0 | 17.9 | 114.5 | 37.6 | 298.6 |
| AS-PY- | 0.1 | 9.3 | 3.9 | 32.8 | 22.9 | 197.6 | 47.4 | 54.1 |
| 550 | | | | | | | | |

It will be apparent to those skilled in the art that variations of the process and systems described herein are possible and are intended to be encompassed within the scope of the present invention.

What is claimed is:

1. A coagulant slurry composition that is derived from drinking water treatment residuals, and comprises:
(i) a particulate component having porous particles containing an iron species and an aluminum species; and
(ii) a dissolved component that includes dissolved forms of the iron species and the aluminum species.

2. The coagulant slurry composition of claim 1, wherein at least 1 wt. % of the total weight of iron in the iron species is dissolved in the coagulant slurry composition, and at least 1 wt. % total aluminum in the aluminum species is dissolved in the coagulant slurry composition.

3. The coagulant slurry composition of claim 1, wherein the particulate component is from 10 wt. % to 90 wt. % of the coagulant slurry composition.

4. The coagulant slurry composition of claim 1, wherein the coagulant slurry composition has a pH that is in a range of from (i) 0 to 4.5 or (ii) 11 to 15.

5. The slurry composition of claim 1, wherein the slurry composition has a total iron content that is in a range of from 1 to 75 wt. % on a dry basis.

6. The slurry composition of claim 1, wherein the slurry composition has a total aluminum content that is in a range of from 1 to 75 wt. % on a dry basis.

7. The coagulant slurry composition of claim 1, wherein from 5 wt. % to 90 wt. % of the total weight of iron in the iron species is dissolved in the coagulant slurry composition.

8. The coagulant slurry composition of claim 1, wherein from 5 wt. % to 90 wt. % of the total weight of aluminum in the aluminum species is dissolved in the coagulant slurry composition.

9. The coagulant slurry composition of claim 1, wherein the particles of the particulate component further comprise silica.

10. The coagulant slurry composition of claim 1, wherein the particles of the particulate component further comprise calcium.

11. The coagulant slurry composition of claim 1, wherein at least 50% of the particles of the particulate component have a size of 5 μm or less.

12. The coagulant slurry composition of claim 1, wherein the coagulant slurry composition has a pH of from 0.1 to 3.

13. A method of treating a sewer system that includes biofilms, the method comprising adding the coagulant slurry composition of claim 1 to the sewer system to reduce the production of sulfide and/or phosphate fermentation products in the biofilms.

14. A method of treating wastewater comprising adding the coagulant slurry composition of claim 1 to a clarifying tank in a sewer system.

15. A method of enhancing biogas production in an anaerobic digester that treats sewage sludge, comprising adding the coagulant slurry composition of claim 1 to the anaerobic digester.

16. A method of producing a coagulant composition, the method comprising:
providing a calcined or pyrolyzed powder composition that includes both iron and aluminum from drinking water treatment residuals; and
mixing an acid or base with the powder composition to dissolve a portion of the powder composition and provide a slurry composition that includes a particulate component with particles that includes iron and aluminum and a dissolved component that includes dissolved iron and dissolved aluminum.

17. The method of claim 16, wherein, during the mixing step, further comprising applying sonication to improve a dissolution rate and/or extent of dissolution for the iron and aluminum.

18. The method of claim 16, wherein the providing step comprises dewatering the drinking water treatment residuals.

19. The method of claim 18, wherein dewatering the drinking water treatment residuals includes drying the drinking water treatment residuals so that they have a solids content in a range of from 20% to 100%.

20. The method of claim 16, wherein the providing step comprises subjecting the drinking water treatment residuals to a thermal treatment that calcines or pyrolyzes the powder composition.

21. The method of claim 16, wherein the thermal treatment is a calcination treatment that heats the drinking water treatment residuals to a temperature in a range of from 250° C. to 1000° C. in an oxygen-containing atmosphere for 0.2 h to 24 h.

22. The method of claim 20, wherein the thermal treatment is a pyrolysis treatment that heats the drinking water treatment residuals to a temperature in a range of from 250° C. to 1000° C. in an atmosphere that is substantially devoid of oxygen for 0.2 h to 24 h.

23. The method of claim 16, wherein from 5 wt. % to 90 wt. % of the total weight of iron in the slurry composition is dissolved, and from 5 wt. % to 90 wt. % of the total weight of aluminum in the slurry composition is dissolved.

24. The method of claim 20, further comprising adding at least one additional material to the drinking water treatment residuals before the thermal treatment.
